(19) United States
(12) Patent Application Publication
(10) Pub. No.: US 2025/0298125 A1
(43) Pub. Date: Sep. 25, 2025

(54) Method, System and Apparatus for Classification of Objects in a Radar System

(71) Applicant: Renesas Design India Private Limited, Bengaluru (IN)

(72) Inventors: Ankit Sharma, Bengaluru (IN); Jayakrishnan T, Chelakkara, Dist: Thrissur (IN); Amulya Dwivedi, Ghaziabad (IN); H B Chetan, Bengaluru (IN); Shubham Paul, Bengaluru (IN); Anupama Gupta, Howrah (IN)

(73) Assignee: Renesas Design India Private Limited, Bengaluru (IN)

(21) Appl. No.: 18/973,501

(22) Filed: Dec. 9, 2024

(30) Foreign Application Priority Data
Mar. 21, 2024 (IN) 202441021737

(51) Int. Cl. G01S 7/41; G01S 13/66; G01S 13/91; G09B 9/54

(52) U.S. Cl. CPC G01S 7/415; G01S 13/66; G01S 13/91; G09B 9/54

(57) ABSTRACT

According to an aspect, a radar system comprising a transmitter transmitting a radar signal, a receiver receiving a reflected signal that is a reflection of the radar signal from a plurality of objects, in that the receiver is configured generate a point cloud comprising plurality of points with each point representing a range, a velocity and a position information, a feature extension unit configured to generate a plurality of tracks from the point cloud with each track comprising a corresponding set of points and generating an extended feature set for each track, in that each track representing an object in the plurality of objects and a classifier classifying the plurality of tracks into a set of classes using a reference data derived from the range, the velocity, the position information and the extended features.

### BACKGROUND

### CROSS REFERENCES TO RELATED APPLICATION

This application claims priority from Indian Patent Application No. 202441021737 filed on Mar. 21, 2024 which is incorporated herein in its entirety by reference.

### Technical Field

Embodiments of the present disclosure relate generally to Radar and Surveillance systems and more specifically to classification of objects in a radar systems.

### Related Art

Radar systems are generally employed for object detection, tracking, terrain mapping, surveillance, traffic management, traffic enforcement etc. As is well known, Radars can detect surrounding obstacles or objects and determine information like range, velocity and angle of the object(s) that are in motion or at rest.

Radar system may transmit a sequence of pulses (as in Pulsed radar systems) or may transmit a frequency modulated continuous wave signal (as in FMCW radar) and processes the corresponding signal reflected by objects (reflected signal) to determine one or more parameters such as range (distance), Doppler (velocity), elevation/azimuth (angles) of one or more objects. The distance, velocity and angle are referred to as primary information. This primary information is received per target/point. Often, this primary information is received instantaneously or accumulated over a period of time and is further processed to group points of similar characteristics into clusters (group of points). Clusters are tracked over a time interval of one or several radar frames to turn them into ‘detected objects’ or ‘tracks’. Secondary parameters such as length, breadth, height radar cross section (RCS), trajectory etc., may be derived for these tracks every frame or over a span of several frames. Combination of primary and secondary parameters of detected objects is called as an extended feature set or simply feature set.

In certain applications, the detected objects are required to be classified into different classes. For example, in case of traffic enforcement and/or traffic management and/or toll collection etc., vehicles are required to be classified into certain classes like two-wheeler, light motor vehicle (LMVs), heavy motor vehicles (HMVs) etc.

Conventionally, additional sensing modalities such as video cameras, Lidar (light detection and ranging) technology, etc., are employed in addition to the Radar system to classify the objects detected by the Radar. In other words, information captured through a sensing modality other than radar is used to aid in the classification of objects detected by the radar system. The camera data or additional data assisting the radar system is referred to as the “ground truth” as is well known in the technology area of neural network/machine learning.

FIG. 1A depicts conventional classification techniques. As shown there, the classifier 130 is shown receiving radar data 113 from the radar system 110 and additional data 123 from the supplementary system 120. The supplementary system may be a video camera, LiDAR, etc., and the associated signal processing system. The radar system 110 may include the radar signal processing electronics/processors with associated feature extraction elements. Accordingly, the data on path 113 may be one or more of the radar data, extended feature set, etc. The data on path 123 may be ground truth derived from the system 120. The classifier 130 uses the ground truth 123 to classify the radar data 113 into set of classes and provide the classified radar data on path 139.

One conventional object classification technique is more fully described in a literature titled “A Novel Neural Network for Enhanced Automotive Radar Object Recognition, authored by Xiangyu Gao, Guanbin Xing, and published in IEEE Sensor Journal, 2020, Volume: 21, Issue: 4, dated 15 Feb. 2021. In this approach, time-synchronized Radar and Camera data are collected for preparing a training dataset. The radar data collected is used to obtain “heat maps”, which are usually range-azimuth angle, range-velocity or velocity-angle. These maps are then fed to Convolutional Auto-encoders with the true class supplied by the camera images. The convolutional auto-encoders learn the features of each class with the time-synchronized training data of radar feature set and the true classes, during the training phase. The features from all the encoders are fused in a fusion module, and the classification is done by a convolution neural network (CNN) taking fused features as an input.

FIG. 1B provides the operation of such conventional system. As shown there, the radar system 140 is shown providing raw radar data. The 3D FFT unit 151, range-Doppler-angle heatmap 152 together operates as radar data processor and provides the processed radar data (here, the Heatmaps as features) to the classifier that is CNN160. The CNN 160 is shown receiving the ground truth from the camera system 165 to help the CNN learn features of various classes via supervised learning.

Similarly, another conventional object classification technique is more fully described in a literature titled “Vehicle Classification Based on Convolution Networks Applied to FMCW Radar Signals”, authored by Samuele Capobianco, Luca Facheris, Fabrizio Cuccoli & Simone Marinai. In that, briefly, the FMCW Radar produces a chirp signal that reflects off the target. The signal thus obtained is a one dimensional (1D) temporal signal. A Short Time Fourier Transform (STFT) is performed on the signal by splitting it into smaller moving windows to produce three 2D Range Doppler signatures like up ramp, down ramp and average ramp. The dataset used to train the Neural Network (called DeepRadarNet) contains several training examples for different kind of vehicles, where the true labels are provided by a human that operates as ground truth. FIG. 1C provides the operation of such conventional system. As shown there, the radar system 170 is shown providing raw radar data. The STFT unit 181 and stacker 182 together operate to generate range Doppler images and 3D tensor. The DeepRadarNet 190 is operative as classifier is shown to receive the tensors from the unit 182 and the Groundtruth 195 through manual entry.

Apparently, in the conventional systems, additional data derived from supplementary sensing modality/modalities (other than radar) is first given class-label and the same is employed as training examples for a machine attempting to learn the radar feature set corresponding to the given class-labels—a process typically termed as supervised learning. In general, large data sets are required to be captured and employed in the training phase for machine learning as a starting point for real time operations. Such classifications are inefficient at least when the operating conditions are not known beforehand. That apart, the data in the real time operation may be different from that of the training phase due to operating temperature and installation conditions, device-to-device variations, classes of objects to be encountered, etc., thus, rendering the conventional classification techniques inefficient in many applications. Further, the conventional techniques require strict supervision for training and are not capable of operating autonomously or in a plug-and-play manner. The conventional radar classifiers are not adjustable or alterable online based on operating condition. The conventional systems are computationally intensive to build and train and are therefore are expensive. For example the CNN may require hundreds of GB (gigabytes) of data to train the classifier.

### SUMMARY

According to an aspect, a radar system comprising a transmitter transmitting a radar signal, a receiver receiving a reflected signal that is a reflection of the radar signal from a plurality of objects, in that the receiver is configured generate a point cloud comprising plurality of points with each point representing a range, a velocity and a position information, a feature extension unit configured to generate a plurality of tracks from the point cloud with each track comprising a corresponding set of points and generating an extended feature set for each track, in that each track representing an object in the plurality of objects and a classifier classifying the plurality of tracks into a set of classes using a reference data derived from the range, the velocity, the position information and the extended features.

According to another aspect, a method of classifying a plurality of detected objects in a radar system comprising collecting radar data over multiple numbers of frames, arranging collected data over multiple dimensions, detecting a plurality of tracks representing the plurality of objects, forming clusters over selected dimensions, tracking each track over the multiple frames, identifying and selecting a centroid Data for each cluster, reinforcing the centroid data, comparing reinforced data with a preset threshold value, provide reinforced data as reference for classification when the comparison result is positive and classifying the tracks based on the reference.

Several aspects are described below, with reference to diagrams. It should be understood that numerous specific details, relationships, and methods are set forth to provide a full understanding of the present disclosure. One who skilled in the relevant art, however, will readily recognize that the present disclosure may be practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1A depicts conventional classification techniques.

FIG. 1B provides the operation of one conventional system.

FIG. 1C provides the operation of another conventional system.

FIG. 2 is a block diagram of an example radar system in which various aspects of the present invention may be seen.

FIG. 3 is an example radar transceiver for object detection and recognition in an embodiment.

FIG. 4A illustrates example point cloud in one embodiment.

FIG. 4B is a table illustrating primary radar data.

FIG. 5A is a block diagram illustrating the manner in which the feature extraction block and the object classifier may be implemented in an embodiment.

FIG. 5B is a table illustrating example multi-dimensional clusters.

FIG. 6 is a block diagram illustrating the generation of training data in one embodiment.

FIG. 7A illustrating the data points arranged in the selected two dimensions of RCS on X-Axis and Width on Y axis.

FIG. 7B illustrating the data points arranged in the selected two dimensions of RCS on X-Axis and Velocity on Y axis

FIG. 7C illustrating the data points arranged in the selected two dimensions of height on X-Axis and width on Y axis

FIG. 8 illustrates the manner in which the cluster is formed in an embodiment.

FIG. 9 is a graph illustrating the manner in which the data points are reinforced.

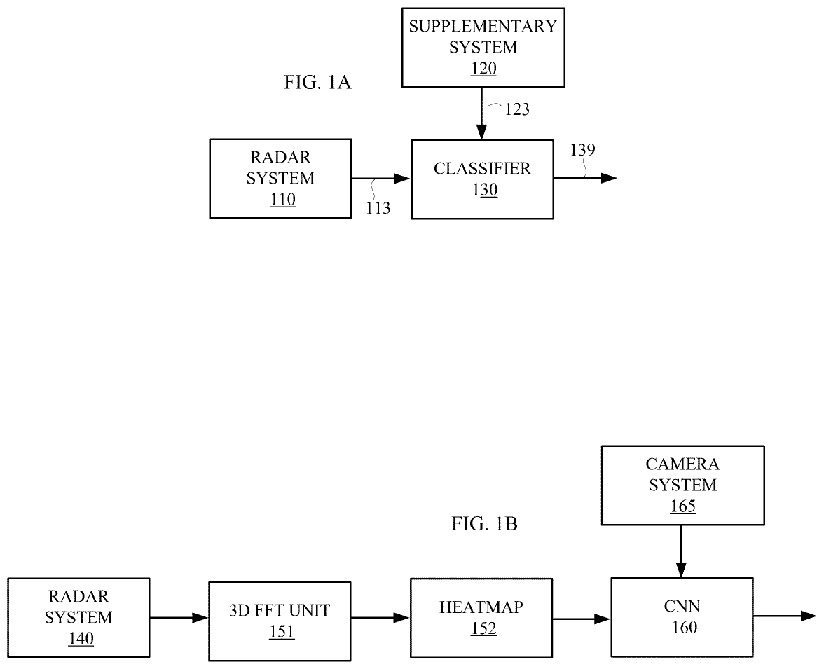

### DETAILED DESCRIPTION OF THE PREFERRED EXAMPLES

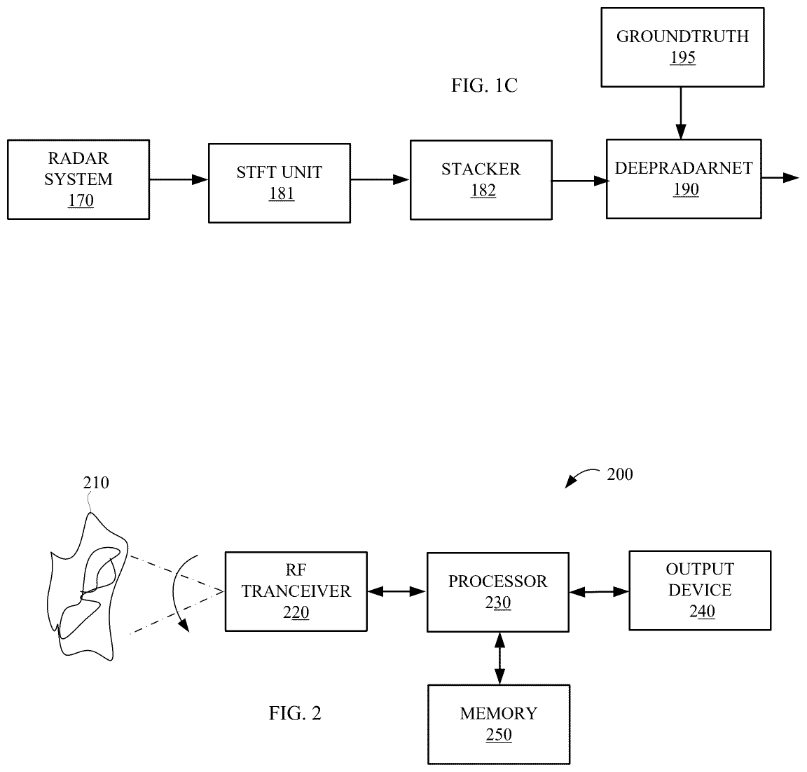

FIG. 2 is a block diagram of an example radar system 200 (environment) in which various aspects of the present invention may be seen. The environment is shown comprising objects 210, Radio Frequency (RF) transceiver 220, processor 230, output device 240 and memory 250. Each element in the system 200 is further described below.

RF transceiver 220 transmits a radar (RF) signal over a desired direction(s) and receives a reflected radar signal that is reflected by the objects210. In one embodiment, the RF transceiver 220 may employ multiple (one or more) receiving antennas to receive the reflected RF signal and multiple (one or more) transmitting antenna for transmitting the radar signal. Accordingly, the transceiver 220 may employ these multiple transmitting/receiving antennas in several of multiple input and multiple output (MIMO) configurations to form desired transmitting and receiving RF signal beam (often referred to as Beam forming) to detect objects from the reflected signal. The objects 210 may comprise a terrain, terrain projections, single object, multiple objects, stationary object, moving object, live objects etc.

Processor 230 conditions and processes the received reflected RF signal to detect one or more objects (for example 210) and determines one or more properties of the objects. The properties of the object thus determined (like shape, size, relative distance, velocity, position in terms of azimuth and elevation, etc.) are provided to the output device 240. In one embodiment, the processor 230 performs classification of the object so detected. The processor 230 comprises signal conditioner to perform signal conditioning operations and provides the conditioned RF signal for digital processing. The memory 250 may store RF signal like samples of the reflected RF signal for processing. The processor 230 may temporarily store received data, signal samples, intermediate data, results of mathematical operations, etc., in the memory 250 (such as buffers, registers etc.,). In an embodiment, the processor 230 may comprise group of signal processing blocks each performing the specific operations on the received signal and together operative to detect object and its characteristics/properties. For example, the processor may comprise data processing blocks/one or more computers coupled through wireless or wire line communication channels.

The output device 240 comprises navigation control electronics, display device, decision making electronic circuitry, traffic management system, vehicular management systems, toll collection system and other controllers/systems for navigation, display and further processing the received details of the objects. Accordingly, the system 200 may be deployed as part of unmanned vehicles, driver assistant systems, for obstacle detection, navigation and control, terrain mapping, traffic control, toll control etc.

The RF transceiver 220, processor 230, and memory 250 are implemented as an Integrated Circuit coupled with computing machines. In that, certain operations of signal processing may be performed within the integrated circuit and object classification may be performed on the computing machines or the object classification may also be performed within the IC. The manner in which the transceiver 220 and the processor 230 (together referred to as Radar object classifier) may be implemented in an embodiment is further described below.

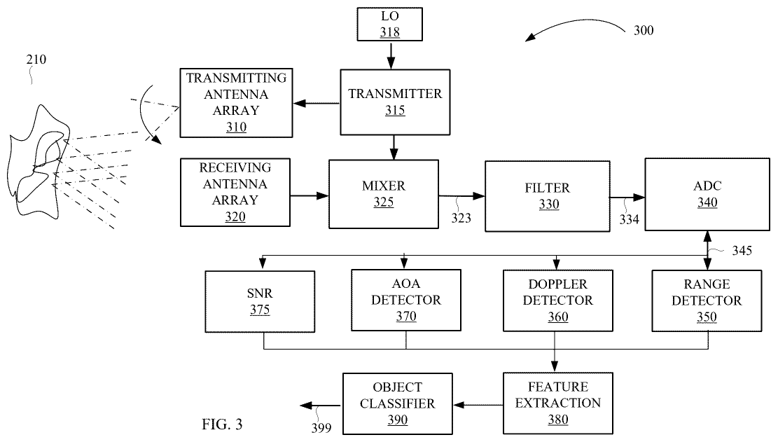

FIG. 3 is an example radar transceiver for object detection and recognition in an embodiment. The radar transceiver 300 is shown comprising transmitting antenna array 310, transmitter block 315, Local Oscillator (LO) 318,receiving antenna array 320, mixer 325, filter 330 Analog to digital convertor (ADC) 340, Range Detector350, Doppler Detector360, Angle of Arrival (AoA) Detector 370, signal to noise ratio (SNR) estimator 375, Feature Extraction Block 380 and Object Classifier 390. Each element is described in further detail below.

The transmitting antenna array 310 and the transmitter 315 operate in conjunction to transmit RF signal over a desired direction. The transmitter 315 generates a radar signal for transmission and provides the same to the transmitting antenna array 310 for transmission. The transmitting antenna array 310 is employed to form a transmit beam with an antenna aperture to illuminate objects at suitable distance and of suitable size. Various known beam forming techniques may be employed for changing the illuminated region. The transmitter 315 may generate a radar signal comprising sequence of pulses (as in pulsed radar system) and/or sequence of chirps (as in Frequency Modulated Continuous Wave (FMCW) radar system).

The receiving antenna array 320 comprises antenna elements, each element capable of receiving reflected RF signal. The receiving antenna array 320 is employed to form an aperture to detect objects with a desired resolution (for example object of suitable size). The RF signal received on each element corresponding to one transmitted RF signal (either pulses or chirps) is provided to the mixer 325.

The Mixer 325 mixes RF signal received on each antenna element in the array with the transmitted RF signal (local oscillator frequency) to generate an intermediate frequency signal (IF signal). In that the mixer 325 may comprise number of complex or real mixers to mix each RF signal received on the corresponding antenna elements. Alternatively, the mixer 325 may comprise of fewer mixers multiplexed to perform desired operation. The number of intermediate frequency (IF) signal is provided on path 323 to filter 330. The filter 330 passes the IF signal attenuating the other frequency components (such as various harmonics) received from the mixer.

The filter 330 may be implemented as a pass band filter to pass a desired bandwidth (in conjunction with chirp bandwidth BW). The filtered IF signal is provided on path 334 to ADC 340.

The ADC 340 converts IF signal received on path 334 (analog IF signal) to digital values. The ADC 340 may sample the analog IF signal at a sampling frequency Fs and convert each sample value to a bit sequence or binary value. The digitized samples of IF signal (digital IF signal) is provided for further processing.

The Range Detector (FFT) 350 detects the range from the received signal. For example, the range detector 350 may perform FFT on the digital IF samples to generate plurality of ranges of the plurality of reflected signals (from objects 210). In particular, range FFT 350 performs FFT on digital IF signal corresponding to each chirp. The Range FFT 350 produces peaks representing the ranges of the plurality of reflecting points on the objects.

The Doppler Detector 360 detects the Doppler (or velocity) of each ranges (points on one or more objects) detected in block 350. For example, the Doppler detector 360 may perform FFT operation on the ranges across chirps. The peaks in the Doppler FFT represent the Doppler of the plurality of reflecting points (of objects) or the velocity of the objects. The ranges and Doppler corresponding to plurality of reflecting points on the objects are provided to the AoA detector 370.

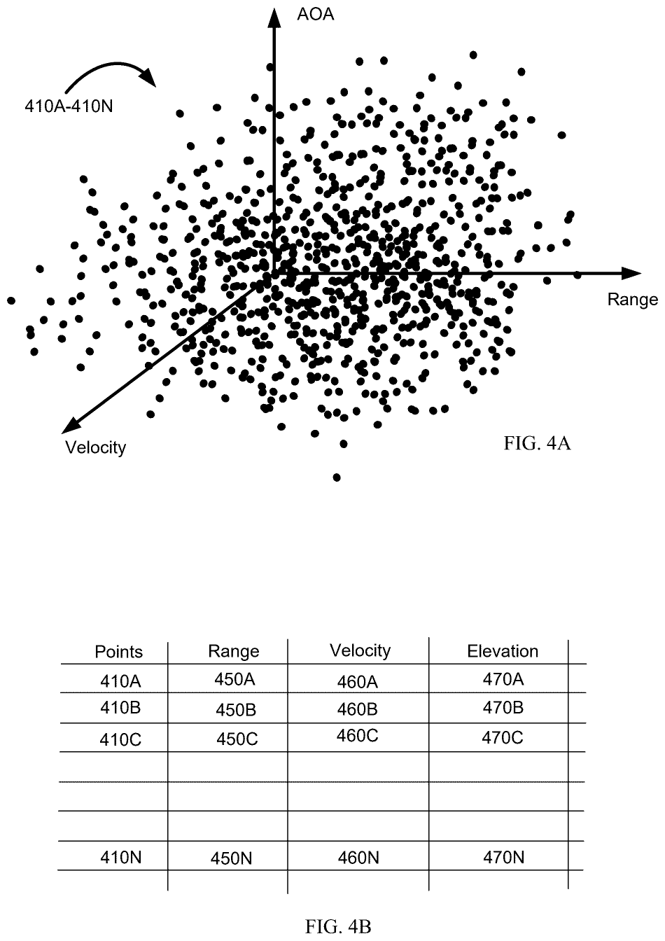

The AoA detector 370 detects position of each reflecting point on the objects and presents a set of points in azimuth or elevation or both. For example, the AoA detector determines the angle of arrival of reflected signal (position/location) and estimates the azimuth and/or elevation of the reflected signal (from the objects) as points to form the point cloud. The range, Doppler, angles and the SNR, together referred to as primary radar data (Primary Features) is provided to the feature extraction block 380. FIG. 4A illustrates example point cloud in one embodiment. In that, each point 410A-410N represents point cloud representing the reflecting points of the objects reflecting the transmitted RF signal. For example, one vehicle (example of an object) may reflect RF signal from its multiple points with each point of reflection forming the point in the point cloud 410A-410N. Each point 410A-410N includes the information of its range, velocity, angles and SNR. FIG. 4B is a table illustrating primary radar data of 410A-410N. The table illustrates the range 450A-N, velocity 460A-N, azimuth 470A-N and elevation 480A-N of each point 410A-410N (SNR is avoided only for succinct representation). While the elements 310-370 are described in brief for completeness, any known techniques for generating the point clouds 410A-410N may be employed and all such primary radar data generation system are made part of this disclosure.

The feature extraction block 380 extracts additional features of the objects from the primary radar data. The additional features (additional to range, velocity, angles and SNR) may comprise the length, width, height, trajectory, heading, Doppler distribution, radar cross section (RCS) of the object, for example. Both primary and additional features (together referred to as features) are provided to the object classifier 390.

The object classifier 390 receives/monitors the features to classify objects into different predefined classes. For example, the classifier may classify the objects into small sized vehicles (two wheeler), medium sized vehicle (like car) and large sized vehicles (like trucks) so on and forth, when in case of detecting the vehicles. Alternatively, the classifier may also classify, small, medium, and large buildings as well. In one embodiment, the object classifier 390 classifies the objects without the aid of any external information outside of the data generated by the radar system 300. In one embodiment, the feature extraction block 380 and the object classifier 390 operate in conjunction on the data received over multiple frames. As is well known in the art, one frame comprises plurality of pulses/chirps transmitted at predefined time intervals. The reflected signals received over one frame on multiple antennas are processed to determine range, velocity, and angle of arrival (primary radar data).

The manner in which the feature extraction block 380 and the object classifier 390 may be implemented in an embodiment to classify the object without the aid of external information is further described below.

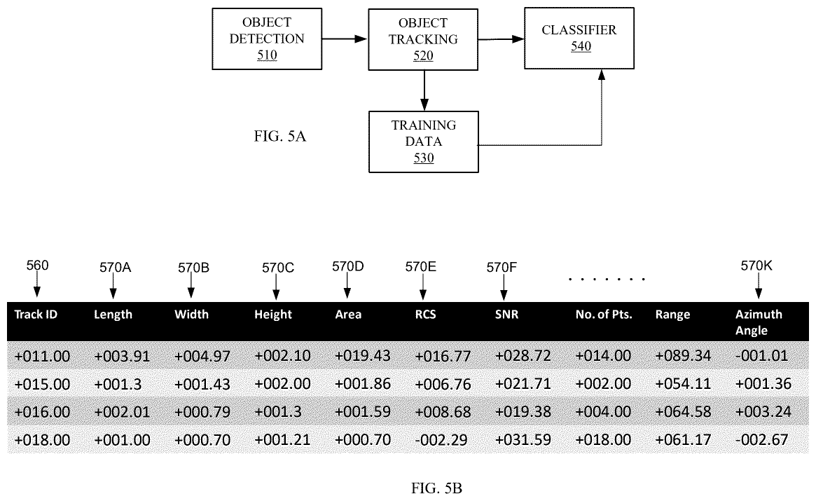

FIG. 5A is a block diagram illustrating the manner in which the feature extraction block 380 and the object classifier 390 may be implemented in an embodiment. The block diagram is shown comprising detection block 510, object tracking block 520, training data 530 and object classifier 540. In that, the detection block 510 detects point(s) from the reflected signals. The object tracking block 520 is configured to perform operations of grouping points in the point cloud to form clusters that are representative of different objects and track the clusters over time to collect extended features of these tracks over an interval of time. The classifier 540 has a training phase followed by a classification phase and repeated whenever required. In one embodiment, the object tracking block 520 receives the detected point cloud along with their associated primary features (including but not limited to range, Doppler velocity, angles and SNR) from the Detection block 510.The object tracking block 520 generates clusters from the received point cloud based on one or more parameters or features and draws an extended feature set per cluster per time instant in addition to tracking this feature set and the associated cluster over their lifetime, thus forming tracks. Each track is thus associated with a feature set history.

FIG. 5B is a table illustrating example multi-dimensional clusters that are being tracked. In that, the Track ID 560 is representing the tracks. Each track is associated to example features 570A-570K. For example, dimension 570A representing the feature “length”, dimension 570B representing the width, dimension 570C representing the height, dimension 570D representing the area, dimension 570E representing the radar cross section, and dimension 570F representing the Signal to Noise Ratio (SNR), for example. The classifier 540 classifies the objects/tracks into one of the predetermined classes based on the training data 530. In one embodiment, the object detection block 510 and object tracker 520 generate the training data 530 (online) from the primary radar data and extended features obtained over multiple frames. The training data 530 operate as reference for classification (what is conventionally referred to as ground truth). Thus, the radar system independently generates for ground truth to train the classifier in an unsupervised manner, as against the prior art that need to employ additional sensing modalities like camera, LiDAR, etc along with labelled/annotated ground truth generated offline to train the classifier in a supervised manner. The Manner in which the training data may be generated in an embodiment is further described below.

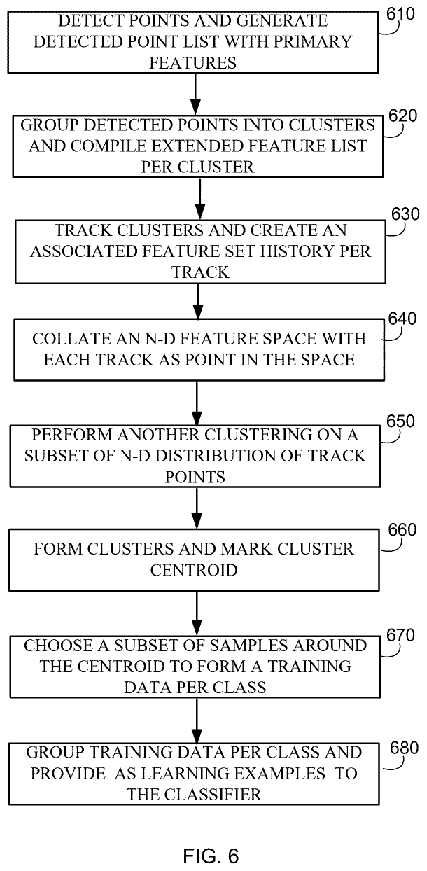

FIG. 6 is a block diagram illustrating the generation of training data 530 in one embodiment. In block 610, points are detected and a point list with primary features is generated. In block 620, the detected points are grouped into clusters and an extended feature list per cluster is compiled. In block 630, the clusters are tracked over multiple frames and an associated feature set history per track is created. In block 640, an n-D feature space is collated with each track as point in the n-D feature space. Multiple of these tracks with each track having multiple instances over time form a dense n-D spatial distribution. In block 650, another clustering of track points from a subset of N-D distribution or from the complete n-D distribution is formed. One example may be a k-mean clustering. In block 660, cluster centroids are marked for the formed clusters. Further, the marked cluster centroid may be reinforced with a-priori information when available. In block 670, a subset of samples around the centroid is chosen to form a training data per class. In that, each cluster is representative of a class, forms training data for that class. In bock 680, grouping of training data per class is performed and provided as learning examples to the classifier.

For example, detected points and their features are obtained from the Detection block 510 of FIG. 5A. These points are processed and grouped into clusters and an extended feature list per cluster is prepared. The Object Tracking unit 520 of FIG. 5A monitors these clusters, associating them over time and prepares a feature set history per track. The feature set history contains the evolution of the feature set per track over time. Then, an n-dimensional feature space is prepared where each track and its occurrences over time are laid out onto this n-dimensional feature space. A second clustering is now performed on a subset or the entire n-dimensional feature space with multiple tracks and their multiple occurrences over time considered as individual points in this space. As an example, k-means clustering could be performed in case the number of classes is known a-priori, otherwise unsupervised forms of clustering can be used. Cluster centroids are calculated on the clusters that represent class-specific centroid points. These cluster centroids may be reinforced with information about the classes, if available. Points around each cluster centroid are picked up as training examples for the particular class and are provided to the classifier to learn the underlying feature set. This way, the training data/ground truth is generated online by the classifying setup.

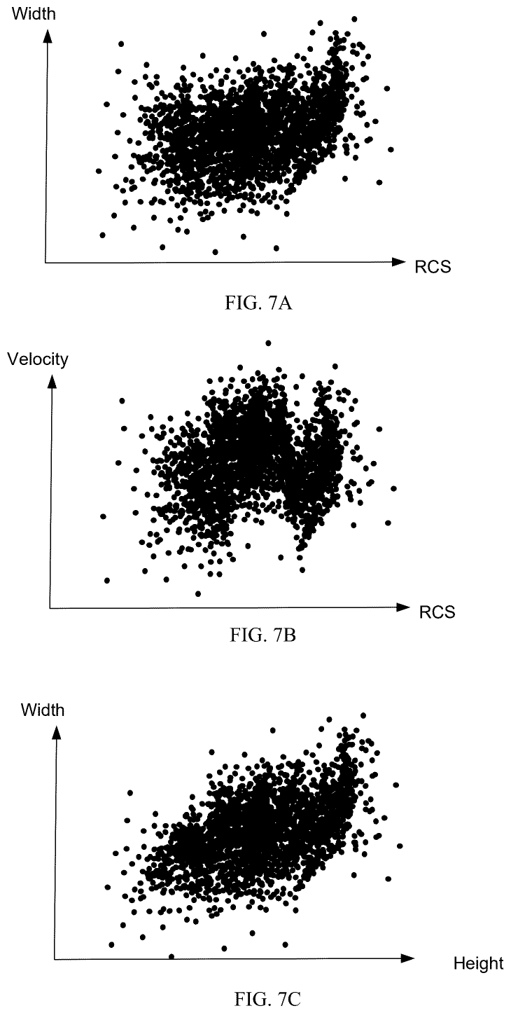

FIG. 7A-7C illustrates sample radar data received over multiple frames and arranged over multiple selected dimensions. In that, the FIG. 7A illustrating the data points arranged in the selected two dimensions of object RCS on X-Axis and object Width on Y axis. Similarly, the FIG. 7B illustrating the data points arranged in the selected two dimensions of RCS on X-Axis and Velocity on Y axisand FIG. 7C illustrating the data points arranged in the selected two dimensions of height on X-Axis and width on Y axis, for example. In one embodiment, the clusters are formed taking the distribution over RCS and Width as in FIG. 7A. Similarly, clusters may be formed using other dimensions as may be the case.

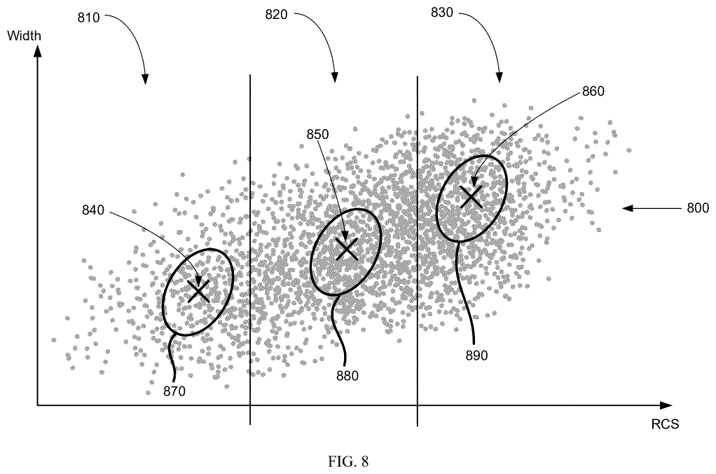

FIG. 8 illustrates a manner in which clusters are formed in an embodiment. In that, the track data points are shown arranged over N dimensions with N equal to 2, for example. The selected features are object/track RCS and the object/track Width. The data points are shown segregated into K probable classes with K taking a value equal to 3, for example for classifying objects on road into two-wheelers, small four-wheelers and big four-wheelers. If the required classifications for determining the object type is 5 (pedestrian, bicycle, two-wheeler, car, truck, for example), K is set to 5 and so on. The segregated classes are shown as 810, 820 and 830. In that, any known clustering technique may be employed. For example, the K-means clustering that provides K number of clusters from the observations, in this case, number of observations may be the number of data points 800 collected over multiple desired number of radar data frames (for example 10,000 frames) and K is the number of clusters. By assigning K=3, the clustering algorithm will deliver three clusters 810, 820 and 830. In the FIG.8, centroids 840, 850 and 860 represent the centroids (a middle point or highest concentration point) of the distribution in the clusters 810-830 respectively. The centroid points 840-860 may be obtained by several ways as finding the mean, finding the n-th percentile point, etc., for example. The data points 870, 880 and 890 representing the selected data points from the clusters 810-830, act as training data 530 to begin with. The data points 870-890 are sigma level sets of data distribution 810-830. For example, when, nth sigma level set may be represented as “n-σ” as is well known in the art, n may be set to a value equal to 1, the 1-σ level set of data points 870-890 may be obtained.

In one embodiment, the sigma level sets 870-890 may be obtained from relation:

$$x = μ + n {Σ}^{1 / 2} [ \begin{matrix}cos θ \\ sin θ\end{matrix} ] ∀ θ ∈ [ 0 , 2 π ] ,$$

wherein μ representing the expected vector per cluster or class (each point in the selected training data points 870, 880 and 890 is a n-D vector over the track's n-D feature space, for example for 2-D vector of RCS and width,

$$μ = \frac{1}{N} {\sum }_{i = 0}^{N - 1} {v}_{i ,}$$

where each vᵢ is a training data point and hence a 2-D vector as

$${v}_{i} = [ \begin{matrix}{RC S}_{i} \\ {Width}_{i}\end{matrix} ] ) ,$$

n representing the desired sigma level set, Σ representing the covariance matrix of the measured vector over then-dimensional space, for example. Two dimensional space (RCS, width) and θ varies from 0 to 2π to construct ellipsoids around the clusters/class centroid.

In one embodiment, the Σ may be represented (for the RCS, width) as:

$$Σ = [ \begin{matrix}var ( RCS ) & cov ( R CS , width ) \\ cov ( RC S , width ) & var ( width )\end{matrix} ] ,$$

where var(a)=variance of a random number a and cov(a,b)=cross covariance between two random numbers a and b. by invoking Weak law of Large numbers, above relation may be further represented as:

$$Σ = [ \begin{matrix}{\sum }_{i = 1}^{i = N} \frac{{( {x}_{i} - {μ}_{RCS} )}^{2}}{N} & {\sum }_{i = 1}^{i = N} \frac{( {x}_{i} - {μ}_{RCS} ) ( {y}_{i} - {μ}_{width} )}{N} \\ {\sum }_{i = 1}^{i = N} \frac{( {x}_{i} - {μ}_{RCS} ) ( {y}_{i} - {μ}_{width} )}{N} & {\sum }_{i = 1}^{i = N} \frac{{( {y}_{i} - {μ}_{width} )}^{2}}{N}\end{matrix} ] ,$$

in that, x_i′s and y_i′s represent the i-th RCS and width values from the training data points and μ_RCS and μ_width represent the mean/expected RCS and width values for a particular cluster/class.

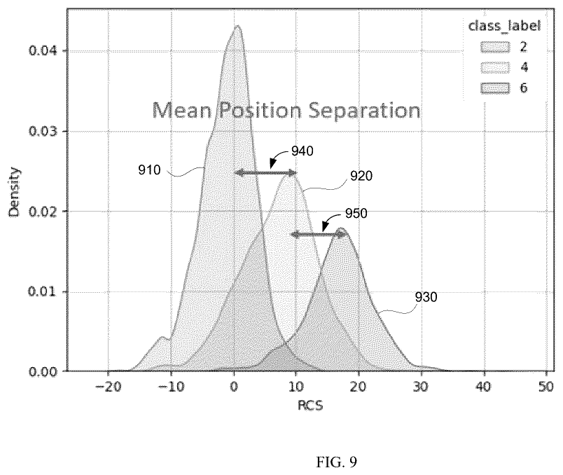

In certain embodiment, the data points 870-890 may be further validated or reinforced. FIG. 9 is a graph illustrating the manner in which the data points 870-890 are reinforced. In the graph, X axis representing the RCS and Y axis representing it's corresponding probability density. As shown there the, curve 910, 920 and 930 represents the Probability Distribution/Density Function (PDF) of cluster 870, 880, and 890 respectively. The data points 870-890 are selected when the mean position separation 940 and 950 are greater than a threshold. For example, when the mean position separation 940 and 950 are greater than or equal to 10 dB in RCS, the data points 870-890 are determined as valid.

It may be appreciated that the data points 800 may be accumulated over the number of frames until the data points 870-890 meets the required thresholds. Subsequently, the data points 870-890 are provided to the classifier for classification. The classifier 540 may use the data points 870-890 training data to train itself to learn the underlying feature distribution of each class and be able to generalize the learning to new examples when the classifier starts to actually classify objects.

While various examples of the present disclosure have been described above, it should be understood that they have been presented by way of example, and not limitation. Thus, the breadth and scope of the present disclosure should not be limited by any of the above described examples, but should be defined in accordance with the following claims and their equivalents.

What is claimed is:

1. A radar system comprising:
a transmitter transmitting a radar signal;
a receiver receiving a reflected signal that is a reflection of the radar signal from a plurality of objects, in that the receiver is configured to generate a point cloud comprising plurality of points with each point representing a range, a velocity, an angle and a signal to noise ratio (SNR) information;
a feature extraction unit configured to generate a plurality of tracks from the point cloud and generating an extended feature set for each track, in that each track representing an object in the plurality of objects; and
a classifier classifying the plurality of tracks into a set of classes using a reference data derived from the range, the velocity, the position information and the extended features.

2. The radar system of claim 1, where in the extended feature set comprising a width and a radar cross section (RCS) and the set of class comprising two-wheeler, cars and trucks, wherein plurality of tracks are generated by generating three clusters of points from the point cloud when arranged over the RCS and width.

3. The radar system of claim 1, where in the feature extension unit is configured to generate the reference data.

4. The radar system of claim 3, where in the feature extension unit is configured to select a first set of points from each cluster that are within a first distance from its centroid.

5. The radar system of claim 4, where in the feature extension unit is configured to select a first set of points from each cluster when the centroids are separated by a threshold.

6. A method of classifying a plurality of detected objects in a radar system comprising:
receiving a reflected signal that is a reflection of a radar signal from a plurality of objects;
generating a point cloud, from the reflected signal, the point cloud comprising plurality of points with each point representing a range, a velocity, an angle and a signal to noise ratio (SNR) information;
grouping the plurality of points into clusters and compiling an extended feature list per cluster;
tracking each cluster and creating an associated feature set history per track;
collating an n-dimensional (n-D) feature space to form an n-D distribution of track points with each track as point in the space;
performing another clustering on a subset of n-D distribution of track points to generate a second set of clusters
identifying centroid of each cluster in the second set of cluster;
selecting a subset of samples around the centroid to form a training data per class; and
grouping training data per class and providing as learning examples to the classifier classifying the cluster into one of the classes.
